(19) United States
(12) Patent Application Publication
(10) Pub. No.: US 2014/0117745 A1
(43) Pub. Date: May 1, 2014

(54) ENHANCED BICYCLE BRAKING SURFACES

(71) Applicants: Mark Wilke, Oconomowoc, WI (US); Tony Damhoff, Lake Mills, WI (US)

(72) Inventors: Mark Wilke, Oconomowoc, WI (US); Tony Damhoff, Lake Mills, WI (US)

(73) Assignee: Trek Bicycle Corp., Waterloo, WI (US)

(21) Appl. No.: 14/062,693

(22) Filed: Oct. 24, 2013

Related U.S. Application Data
(60) Provisional application No. 61/718,732, filed on Oct. 26, 2012.

(51) Int. Cl. B60B 21/08

(52) U.S. Cl. CPC B60B 21/08
USPC 301/6.9; 427/299; 427/446; 427/569; 427/255.7; 156/280; 205/205; 204/192.15

(57) ABSTRACT

An apparatus including a bicycle wheel rim. At least a portion of the bicycle wheel rim can include a braking material. The braking material can have a roughness of about 1 micron to about 80 microns.

### CROSS-REFERENCE TO RELATED PATENT APPLICATIONS

This application claims the benefit of U.S. Provisional Application No. 61/718,732, filed Oct. 26, 2012, titled “ENHANCED BICYCLE BRAKING SURFACES,” which is incorporated herein by reference in its entirety.

### BACKGROUND

The present invention relates generally to the field of bicycle wheels and more particularly to the field of braking surfaces.

Bicycle wheels can be made, for example, of steel, aluminum, and fiber reinforced plastics such as carbon fiber. Bicycle wheels can include, for example, a designated braking surface, such as an area on a rim, or a rotor. Heat buildup and track conditions can affect braking performance. For example, when a bicycle wheel gets wet, the performance of a braking system can decrease. Therefore, improved bicycle braking surfaces and methods of creating bicycle braking surfaces are needed.

### SUMMARY

One illustrative embodiment is related to an apparatus including a bicycle wheel rim. At least a portion of the bicycle wheel rim can include a braking material. The braking material can have a roughness of about 1 micron to about 80 microns.

Another illustrative embodiment is related to a method. The method can include roughening a bicycle wheel rim surface. An adhesive layer can be applied to the bicycle wheel rim surface. A strike layer can be applied to the adhesive layer. A friction material layer can be applied to the strike layer. The friction material layer can have a roughness of about 1 micron to about 80 microns.

Another illustrative embodiment is related to apparatus including a bicycle wheel rim. At least a portion of the bicycle wheel rim can include an adhesive layer, a strike layer, and a friction material layer. The friction material layer can include grains with an average grain size between 2 nm and 50,000 nm. The bicycle wheel rim can include a fiber reinforced plastic having a glass transition temperature greater than about 265 degrees Fahrenheit.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a side view of a bicycle in accordance with an illustrative embodiment.

FIG. 2 is a side view of a bicycle wheel rim in accordance with an illustrative embodiment.

FIG. 3 is a section view of a tubular bicycle wheel in accordance with an illustrative embodiment.

FIG. 4 is a section view of a clincher bicycle wheel in accordance with an illustrative embodiment.

FIG. 5 is a section view of a tubular bicycle wheel rim in accordance with an illustrative embodiment.

FIG. 6 is a section view of a clincher bicycle wheel rim in accordance with an illustrative embodiment.

FIG. 7 is a section view of a tubular bicycle wheel rim in accordance with an illustrative embodiment.

FIG. 8 is a section view of a clincher bicycle wheel rim in accordance with an illustrative embodiment.

FIG. 9 is a side view of a bicycle wheel rotor in accordance with an illustrative embodiment.

FIG. 10 is a section view of the bicycle wheel rotor of FIG. 9 in accordance with an illustrative embodiment.

FIG. 11 is a flow diagram of the braking material application process in accordance with an illustrative embodiment.

FIG. 12 is a diagram of a graph of dry/wet braking force in accordance with an illustrative embodiment.

FIG. 13 is a diagram of a graph of wet conditions stopping distance in accordance with an illustrative embodiment.

FIG. 14 is a diagram of a graph of braking response for a carbon rim with cork brake pad in accordance with an illustrative embodiment.

FIG. 15 is a diagram of a graph of braking response for a carbon rim with braking material with Shimano™ R-55C3 brake pad 1500 in accordance with an illustrative embodiment.

FIG. 16 is a diagram of a graph of rim temperature profiles 1600 in accordance with an illustrative embodiment.

FIG. 17 is a section view of a tubular bicycle wheel rim 1700 in accordance with an illustrative embodiment.

### DETAILED DESCRIPTION OF THE ILLUSTRATIVE EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

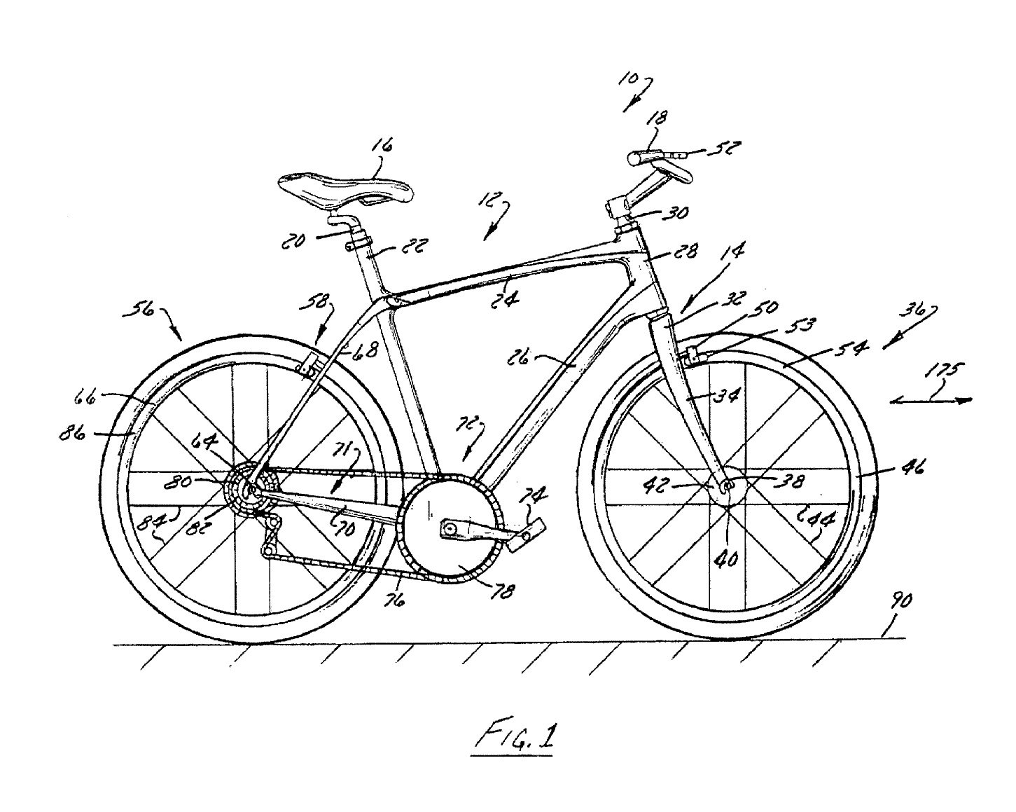

The present disclosure is directed to an enhanced bicycle braking surface and method of enhancing a bicycle braking surface. Referring to FIG. 1, a side view of a bicycle 10 in accordance with an illustrative embodiment is shown. The bicycle 10 can have a frame assembly 12. The bicycle 10 can include a seat 16 and handlebars 18 that are attached to frame assembly 12. A seat post 20 can be connected to seat 16 and can slidably engage a seat tube 22 of the frame assembly 12. A top tube 24 and a down tube 26 can extend forwardly from the seat tube 22 to a head tube 28 of the frame 12. Handlebars 18 can be connected to a stem or steer tube 30 that can pass through the head tube 28 and can be connected or integrally formed with a fork crown 32. The handlebar 18 can include a stem that is constructed to slidably engage an interior cavity of the steer tube 30. One or more of the structures of bicycle 10 and frame assembly 12 can be constructed from similar materials, a variety of different materials, and various combinations thereof. The frame assembly 12 and seat tube 22 can be formed of metal-type materials, such as steel, aluminum-type materials, fiber reinforced plastic, carbon fiber materials, and/or materials that are sufficiently formable and robust enough to support a rider of bicycle 10.

A fork assembly 14 can include a pair of fork blades or fork legs 34 that can extend from generally opposite ends of a fork crown 32 and can be constructed to support a front wheel assembly 36 at an end thereof or a dropout 38. The dropouts 38 can engage generally opposite sides of an axle 40 constructed to engage a hub 42 of the front wheel assembly 36. A number of spokes 44 can extend from hub 42 to a rim 46 of the front wheel assembly 36. A tire 48 can be engaged with rim 46 such that rotation of the hub 42 and the rim 46, relative to the fork legs 34, rotates the tire 48. The rim 46 can be covered with a brake material, in part or in its entirety, to enhance braking characteristics.

The bicycle 10 can include a front brake assembly 50 having an actuator 52 attached to handlebars 18 and a pair of brake pads 53 positioned on generally opposite sides of front wheel assembly 36. The brake pads 53 can be constructed to engage a brake wall 54 of the rim 46 thereby providing a stopping or slowing force to front wheel assembly 36. A rear wheel assembly 56 can include a brake assembly 58 similar to the front wheel brake assembly 50. Brake assemblies 50, 58 can be any brake configuration such as, but not limited to, a rim brake or disk brake assembly wherein a rotor and a caliper are positioned proximate one or more of front wheel axle 40 or a rear axle 64, respectively. The rotor can be covered with a brake material, in part or in its entirety, to enhance braking characteristics. A rear wheel 66 can be positioned generally concentrically about rear axle 64.

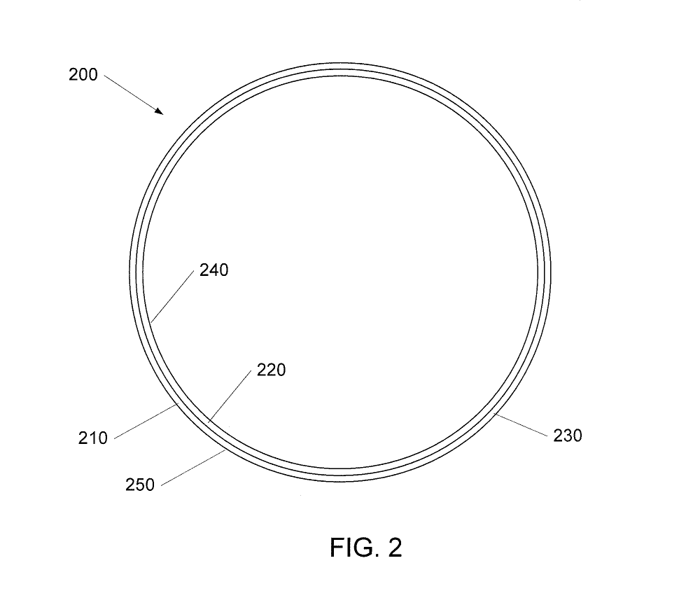

A pair of seat stays 68 (FIG. 2) and a pair of chain stays 70, 71 can extend rearward relative to the seat tube 22 and the offset rear axle 64 from a crankset 72. The crank set 72 can include a set of pedals 74 that can be operationally connected to a flexible drive member such as a chain 76 via one or more variable diameter chain gears or a chain ring or sprocket 78. Rotation of chain 76 can communicate a drive force to a gear cluster 80 positioned proximate rear axle 64. The gear cluster 80 can be generally concentrically orientated with respect to the rear axle 64 and can include a number of variable diameter gears.

The gear cluster 80 can be operationally connected to a hub 82 of the rear wheel 66. A number of spokes 84 can extend radially between the hub 82 and a rim 86 of rear wheel 66 of rear wheel assembly 56. The rim 86 can be covered with a brake material. Rider operation of the pedals 74 can drive the chain 76 thereby driving the rear wheel 66 which in turn propels the bicycle 10. The fork assembly 14 can be constructed to support a forward end 88 of the bicycle 10 above a ground surface 90. The handlebar 18 can be connected to the frame 12 and the fork assembly 14 such that operator manipulation of the handlebar 18 can be communicated to the fork assembly 14 to facilitate rotation of the front wheel assembly 36 relative to the frame assembly 12 along a longitudinal axis, indicated by arrow 175, of the bicycle 10. Manipulation of the handlebar 18 can steer the bicycle 10 during riding.

The construction of bicycle 10 depicted in FIG. 1 is merely exemplary of a number of bicycle configurations. Whereas bicycle 10 is shown as what is commonly understood as a street or road bike, the present disclosure is applicable to a number of bicycle configurations including those bicycles with more aggression suspension systems commonly found in off-road or mountain bike frame configurations, and/or hybrids, cross-over or multi-purpose bicycle frame configurations.

Referring to FIG. 2, a side view of a bicycle wheel rim 200 in accordance with an illustrative embodiment is shown. The bicycle wheel rim 200 can include a sidewall 210 and a support structure 220. The sidewall 210 can be located from an apex 250 to the support structure 220. The support structure 220 can include a spoke bed 240. The sidewall 210 can include a brake track 230 where a brake pad contacts the bicycle wheel rim 200. The apex 250 can be a point where a tire meets the sidewall 210.

The bicycle wheel rim 200 can be made of steel, aluminum, titanium, plastics, fiber reinforced plastics, or any other material. The bicycle wheel rim 200 can be made of a plurality of materials. In one embodiment, the bicycle wheel rim 200 can be made of a fiber reinforced plastic such as carbon fiber. In other embodiments, fibers such as aramid (e.g., Kevlar™), fiberglass, boron fibers, ceramic fibers, nylon, or any other fiber can be used. A resin system of the fiber reinforced plastic can be, for example, an epoxy. The resin can be fortified with particulate, nanotubes, fibers, and nanostructures. In one embodiment, the fiber reinforced plastic can be a thermoset. In another embodiment, the fiber reinforced plastic can be a thermoplastic. The bicycle wheel rim 200 can include bismaleimide, polyphenylene sulfide, polyetherimide, polyamide, polyetheretherketone, polystyrene, nylon, polypropylene, polyethylene, vinyls, acrylics, and/or polycarbonates.

The bicycle wheel rim 200 can have a wall thickness of about 0.05 mm to about 3 mm. When the bicycle wheel rim 200 includes fiber reinforced plastic, a sidewall of the bicycle wheel rim 200 can have 1 to about 7 layers of fiber. In another embodiment, the bicycle wheel rim 200 can have 1 to about 24 layers of fiber. The sidewall of the bicycle wheel rim 200 can include a fiberglass scrim. The bicycle wheel rim 200 can be constructed using layers of different materials.

The plastic can be a resin such as epoxy. The glass transition temperature (Tg) can be any temperature. In one embodiment, the resin can have a glass transition temperature (Tg) greater than 265 degrees Fahrenheit. In another embodiment, the Tg of the resin can be greater than 310 degrees Fahrenheit. In another embodiment, the Tg of the resin can be greater than 340 degrees Fahrenheit. In another embodiment, the Tg of the resin can be in a range of about 300 degrees Fahrenheit to about 420 degrees Fahrenheit.

A glass transition temperature (Tg) of a material can be measured in various ways. Generally, the glass transition temperature (Tg) of a material, such as a plastic or polymer, can be defined as the temperature below which random molecular motion drops to a low level where the material becomes rigid and glass-like. Above Tg, the material exhibits low stiffness and rubbery behavior. Typically, the specific volume of the material will change rapidly and markedly from about a first level to about a second level around the Tg.

The bicycle wheel rim 200 can be coated with a braking material. The braking material can have an enhanced braking surface including a predetermined roughness. Roughness can be defined as the average peak-to-valley distance on the surface of a material. The predetermined roughness can be, for example, in a range of 1-30 microns, a range of 5-15 microns, a range of 1-80 microns, or any other roughness. The predetermined roughness can be matched to a predetermined brake pad material to be used with the bicycle wheel rim 200. For example, the aggressiveness of a rubber compound of a brake pad can be selected to match the predetermined roughness. In addition, the bicycle wheel rim 200 can include a plurality of predetermined roughnesses located in various areas of the bicycle wheel rim 200. For example, a first predetermined roughness can be used on an outside of the brake track 230 and a second predetermined roughness can be used on an inside brake track 230.

The braking material can be a monolithic material or a combination of layers of materials, discussed further below. In one embodiment, the braking material can be a metal or part-metal such as nickel, nickel-cobalt, cobalt-phosphorous, chromium, cobalt-chromium, an alloy thereof, or any other metal. In another embodiment, the braking material can be a ceramic such as a conductive ceramic. In another embodiment, the braking material can be a combination of metal and ceramic. In another embodiment, the braking material can include nanostructures, microstructures, fine particulate, graphene and diamond material. The braking material can include Ni, Cr, Cu, Co, Sn, Fe, Pt, Zn Ag, Au, Mo, W, B, C, P, S, Si, or an alloy thereof. The braking material can include grains having an average grain size between 2 nm and 50,000 nm. In one embodiment, the braking material can include grains having an average grain size between 5,000 nm and 15,000 nm. However, any average grain size can be used. The braking material can include a base or filler material, for example, material plated with a plating bath. The braking material can be about 2 microns to about 200 microns thick; however, any thickness can be used. In another embodiment, the braking material can be about 25 microns to about 100 microns thick.

The braking material can include a seed layer or multiple base layers made, for example, of a metal, adhesive, plastic, resin, foil, or conductive paint. In one embodiment, the seed layer can be made of, for example, copper, nickel, nickel-cobalt, chromium, or an alloy thereof. In another embodiment, the braking material can be deposited on a film applied or co-molded to the bicycle wheel rim 200. In another embodiment, the braking material can be deposited on an aluminum or titanium ring applied or co-molded to the bicycle wheel rim 200. The braking material can be dyed or colored. The braking material can be about 2 microns to about 200 microns thick; however, any thickness can be used. In another embodiment, the braking material can be about 25 microns to about 100 microns thick.

The braking material can be applied to the bicycle wheel rim 200 using a variety of methods, discussed further below. In one embodiment, the braking material can be applied to the bicycle wheel rim 200 using an electroless plating process. In another embodiment, the braking material can be applied to the bicycle wheel rim 200 using an electroplating process. In another embodiment, the braking material can be applied to the bicycle wheel rim 200 using a sputtering process. In another embodiment, the braking material can be applied to the bicycle wheel rim 200 using a thermal spray/plasma deposition process. In another embodiment, the braking material can be applied to the bicycle wheel rim 200 using an evaporation process. In another embodiment, the braking material can be applied using a combination of processes such as plating and sputtering. For example, a base layer of braking material can be applied by plating and a roughness layer can be applied using sputtering or plasma spray.

In one embodiment, the braking material can be located from the apex 250, around the support structure 220, to an apex on the other side of the bicycle wheel rim 200 (not shown). In another embodiment, the braking material can cover the entire bicycle wheel rim 200. In another embodiment, the braking material can cover the brake track 230. Alternatively, the braking material can be located in any portion of the bicycle wheel rim 200.

The braking material can be continuous. In another embodiment, the braking material can be shaped as slashes, dots, or with holes. In another embodiment, the braking material can be shaped as concentric circles within the brake track 230. In another embodiment, the braking material can be shaped as a saw tooth pattern. Alternatively, the braking material can be any shape or configuration.

Advantageously, the braking material of the bicycle wheel rim 200 can enhance wet weather performance. Advantageously, the braking material of the bicycle wheel rim 200 can have hydrophobic properties. Advantageously, the braking material of the bicycle wheel rim 200 can enhance heat dissipation during braking. Advantageously, the braking material of the bicycle wheel rim 200 can enhance the strength of the spoke bed 240 and/or the bicycle wheel rim 200.

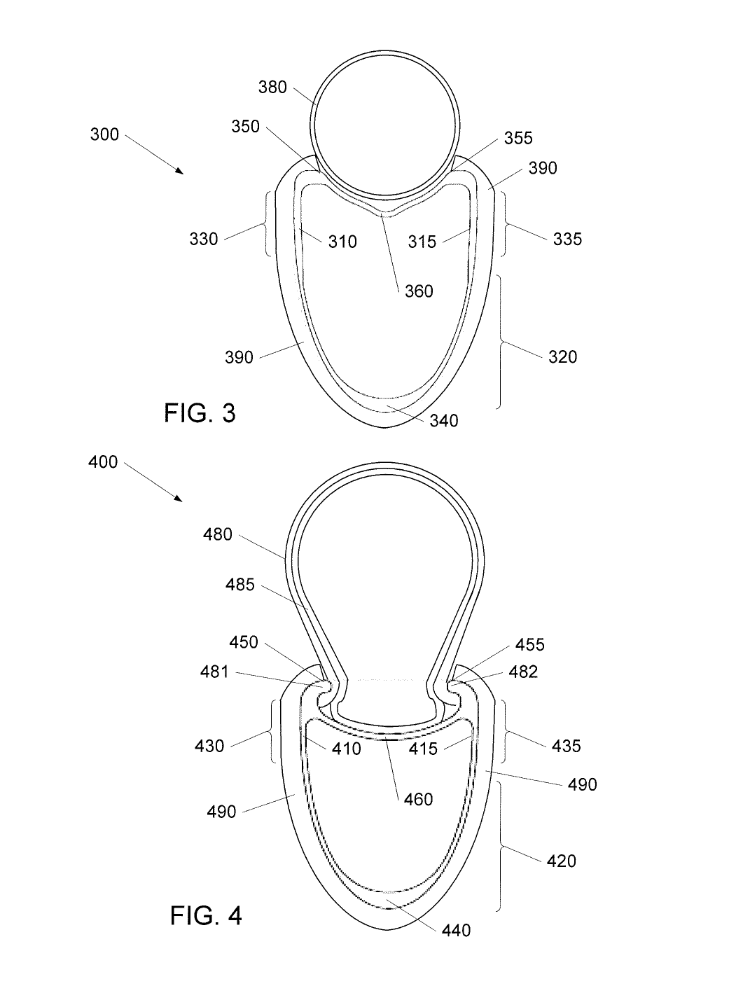

Referring to FIG. 3, a section view of a tubular bicycle wheel 300 in accordance with an illustrative embodiment is shown. The tubular bicycle wheel 300 can include a rim 305. The rim 305 can include a first sidewall 310, a second sidewall 315, a tire well 360, and a support structure 320. The first sidewall 310 can be located from a first apex 350 to the support structure 320. The second sidewall 315 can be located from a second apex 355 to the support structure 320. The support structure 320 can include a spoke bed 340, a first support wall 370, and a second support wall 375. The first sidewall 310 can include a first brake track 330 where a brake pad contacts the tubular bicycle wheel 300. The second sidewall 315 can include a second brake track 335 where a brake pad contacts the tubular bicycle wheel 300. A tire 380 can be secured to the tire well 360 using, for example, adhesive. The first and second apexes 350, 355 can be points where the tire 380 meets the first and second sidewalls 310, 315, respectively. In an alternative embodiment, fins can be placed next to or behind the first brake track 330 and the second brake track 335 to increase heat dissipation.

In one embodiment, the first and second sidewalls 310, 315 can be a fiber reinforced plastic such as a resin, for example, epoxy. The glass transition temperature (Tg) of the plastic/resin can be any temperature. In one embodiment, the resin can have a glass transition temperature (Tg) greater than 265 degrees Fahrenheit. In another embodiment, the Tg of the resin can be greater than 310 or 340 degrees Fahrenheit. In another embodiment, the Tg of the resin can be in a range of about 300 degrees Fahrenheit to about 420 degrees Fahrenheit. Plastic/resin with a glass transition temperature (Tg) greater than 310 degrees Fahrenheit can improve heat dissipation and thermal stability. The first and second sidewalls 310, 315 can be about 0.05 mm to about 3 mm thick and have 1 to about 7 layers of fiber or 1 to about 24 layers of fiber. Any wall thickness or number of fiber layers can be used, as described above.

The rim 305 can be coated with a braking material 390 as described above. In one embodiment, the braking material 390 can be located from the first apex 350, around the support structure 320, to the second apex 335. In another embodiment, the braking material 390 can cover the entire rim 305, including the tire well 360. Advantageously, the braking material 390 in the tire well 360 can promote adhesion of the tire 380 to the tire well 360. In another embodiment, the braking material 390 can cover the first brake track 330 and the second brake track 335. Alternatively, the braking material can be located in any portion of the rim 305.

Advantageously, the braking material 390 of the tubular bicycle wheel 300 can enhance wet weather performance. Advantageously, the braking material 390 of the tubular bicycle wheel 300 can enhance heat dissipation during braking. Advantageously, the braking material 390 of the tubular bicycle wheel 300 can enhance the strength of the spoke bed 340 and/or the bicycle wheel rim 300.

Referring to FIG. 4, a section view of a clincher bicycle wheel 400 in accordance with an illustrative embodiment is shown. The clincher bicycle wheel 400 can include a rim 405. The rim 405 can include a first sidewall 410, a second sidewall 415, a tire well 460, and a support structure 420. The first sidewall 410 can include a first tire bead 412. The second sidewall 415 can include a second tire bead 417. The first tire bead 412 and the second tire bead 417 can be located next to the tire well 460. The first sidewall 410 can be located from a first apex 450 to the support structure 420. The second sidewall 415 can be located from a second apex 455 to the support structure 420. The support structure 220 can include a spoke bed 440, a first support wall 470, and a second support wall 475. The first sidewall 410 can include a first brake track 430 where a brake pad contacts the tubular bicycle wheel 400. The second sidewall 415 can include a second brake track 435 where a brake pad contacts the tubular bicycle wheel 400. In an alternative embodiment, fins can be placed next to or behind the first brake track 430 and the second brake track 435 to increase heat dissipation.

A tire 480 can be secured to the first tire bead 412 and the second tire bead tire. The tire 480 can include an inner tube 485 that, when inflated, presses tire beads 481, 482 against the first tire bead 412 and the second tire bead tire well 460, thereby locking the tire 480 to the rim 405. The first and second apexes 450, 455 can be points where the tire 480 meets the first and second sidewalls 410, 415, respectively.

In one embodiment, the first and second sidewalls 410, 415 can be a fiber reinforced plastic such as a resin, for example, epoxy. The glass transition temperature (Tg) of the plastic/resin can be any temperature. In one embodiment, the resin can have a glass transition temperature (Tg) greater than 265 degrees Fahrenheit. In another embodiment, the Tg of the resin can be greater than 310 or 340 degrees Fahrenheit. In another embodiment, the Tg of the resin can be in a range of about 300 degrees Fahrenheit to about 420 degrees Fahrenheit. Plastic/resin with a glass transition temperature (Tg) greater than 310 degrees Fahrenheit can improve heat dissipation and thermal stability. The first and second sidewalls 410, 415 can be about 0.05 mm to about 3 mm thick and have 1 to about 7 layers of fiber or 1 to about 24 layers of fiber. Any wall thickness or number of fiber layers can be used, as described above.

The rim 405 can be coated with a braking material 490 as described above. In one embodiment, the braking material 490 can be located from the first apex 450, around the support structure 420, to the second apex 435. In another embodiment, the braking material 490 can cover the entire rim 405, including the tire well 460. In another embodiment, the braking material 490 can cover the first brake track 430 and the second brake track 435. Alternatively, the braking material can be located in any portion of the rim 405.

Advantageously, the braking material 490 of the tubular bicycle wheel 400 can enhance wet weather performance. Advantageously, the braking material 490 of the tubular bicycle wheel 400 can enhance heat dissipation during braking. Advantageously, the braking material 490 of the tubular bicycle wheel 400 can enhance the strength of the spoke bed 440.

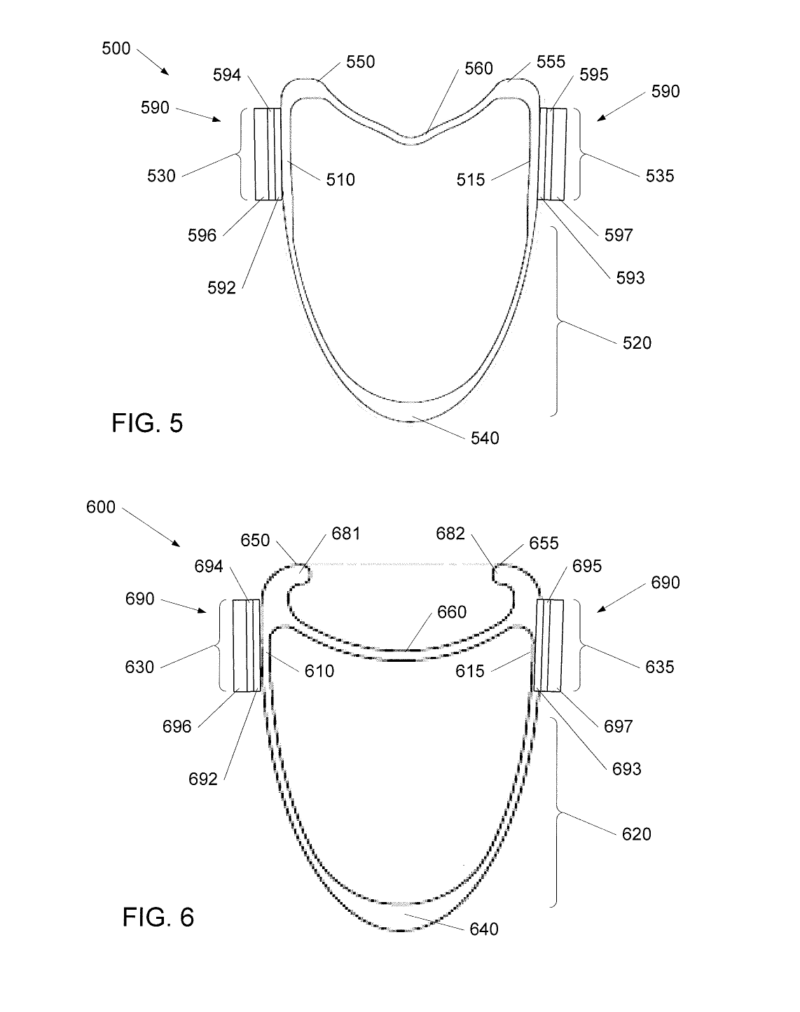

Referring to FIG. 5, a section view of a tubular bicycle wheel rim 500 in accordance with an illustrative embodiment is shown. The tubular bicycle wheel rim 500 can include a first sidewall 510, a second sidewall 515, a tire well 560, a support structure 520, a first apex 550, a second apex 555, a spoke bed 540, a first brake track 530, and second brake track 535, as described above. FIG. 5 depicts braking material 590 located at a first brake track 530 and a second brake track 535.

In one embodiment, the first and second sidewalls 510, 515 can be a fiber reinforced plastic such as a resin, for example, epoxy. The glass transition temperature (Tg) of the plastic/resin can be any temperature. In one embodiment, the resin can have a glass transition temperature (Tg) greater than 265 degrees Fahrenheit. In another embodiment, the Tg of the resin can be greater than 310 or 340 degrees Fahrenheit. In another embodiment, the Tg of the resin can be in a range of about 300 degrees Fahrenheit to about 420 degrees Fahrenheit. Plastic/resin with a glass transition temperature (Tg) greater than 310 degrees Fahrenheit can improve heat dissipation and thermal stability. The first and second sidewalls 510, 515 can be about 0.05 mm to about 3 mm thick and have 1 to about 7 layers of fiber or 1 to about 24 layers of fiber. Any wall thickness or number of fiber layers can be used, as described above.

The braking material 590 can include an adhesion layer 592, 593, a strike layer 594, 595, and a friction material layer 596, 597. The adhesion layer 592, 593 can improve bonding of the strike layer 594, 595 to the first brake track 530 and the second brake track 535. The adhesion layer 592, 593 can be, for example, a resin, a plastic, a conductive material, a metal, nickel, chromium, a soft copper, a hard copper, a silane such as an organosilane, a foil, a conductive paint, a metal fabric, a metalized fabric, and/or or a conductive resin. The adhesion layer 592, 593 can be laid down using a mask. In another embodiment, the adhesion layer 592, 593 can be a conductive foil applied to the first sidewall 510 and the second sidewall 515 or co-molded with the first sidewall 510 and the second sidewall 515. In some embodiments, the adhesion layer 592, 593 can be optional. In other embodiments, the adhesion layer 592, 593 can be integrated into the structure of the tubular bicycle wheel rim 500. For example, a material of the tubular bicycle wheel rim 500 can include a metal base, metal particles or fibers, or prepreg including conductive resin or fibers.

The adhesion layer 592, 593 can be coated with a strike layer 594, 595. The strike layer 594, 595 can provide a substrate for the friction material layer 596, 597. The strike layer 594, 595 can be, for example, a hard copper, nickel, chrome, a nickel-chrome alloy, a cobalt-phosphorous material, aluminum, titanium, gold, or any other metal. The strike layer 594, 595 can be applied to the adhesion layer 592, 593 using a variety of methods including, without limitation, electroless plating, electroplating, sputtering, thermal spray/plasma deposition, and evaporation. Alternatively, the strike layer 594, 595 can be applied directly to a raw rim.

The strike layer 594, 595 can be coated with a friction material layer 596, 597. The friction material layer 596, 597 can provide a roughened surface for a brake pad. The friction material layer 596, 597 can include a formed surface including friction material grains with an average grain size between 2 nm and 50,000 nm. However, any average grain size can be used. The friction material layer 596, 597 can be formed of a plurality of grain types and shapes. For example, the grains can be shaped as spheres, pyramids, threads, rods, flakes, globules, or any other shape. The friction material layer 596, 597 can be formed of a plurality of different grain sizes. For example, a first portion of the friction material layer 596, 597 can be a grain size between 2 nm and 10,000 nm; a second portion of the friction material layer 596, 597 can be a grain size between 10,000 nm and 20,000 nm; and a third portion of the friction material layer 596, 597 can be a grain size between 20,000 nm and 50,000 nm. The friction material layer 596, 597 can include a base or filler material, for example, material plated with a plating bath. The base or filler material can be the same composition as the grains. A finished surface of the braking material 590 can, for example, have a predetermined roughness. The predetermined roughness can be, for example, in a range of 1-30 microns, a range of 5-15 microns, a range of 1-80 microns, or any other roughness. The friction material layer 596, 597 can include multiple layers, including layers of different materials. For example, a first layer can provide flex and a second capping layer can provide a tough surface. The friction material layer 596, 597 can be about 2 microns to about 200 microns thick; however, any thickness can be used. In another embodiment, the friction material layer 596, 597 can be about 25 microns to about 100 microns thick.

Referring to FIG. 6, a section view of a clincher bicycle wheel rim 600 in accordance with an illustrative embodiment is shown. The clincher bicycle wheel rim 600 can include a first sidewall 610, a second sidewall 615, a tire well 660, a support structure 620, a first apex 650, a second apex 655, a spoke bed 640, a first bead 681, a second bead 682, a first brake track 630, and second brake track 635, as described above. FIG. 6 depicts braking material 690 located at a first brake track 630 and a second brake track 635.

In one embodiment, the first and second sidewalls 610, 615 can be a fiber reinforced plastic such as a resin, for example, epoxy. The glass transition temperature (Tg) of the plastic/resin can be any temperature. In one embodiment, the resin can have a glass transition temperature (Tg) greater than 265 degrees Fahrenheit. In another embodiment, the Tg of the resin can be greater than 310 or 340 degrees Fahrenheit. In another embodiment, the Tg of the resin can be in a range of about 300 degrees Fahrenheit to about 420 degrees Fahrenheit. Plastic/resin with a glass transition temperature (Tg) greater than 310 degrees Fahrenheit can improve heat dissipation and thermal stability. The first and second sidewalls 610, 615 can be about 0.05 mm to about 3 mm thick and have 1 to about 7 layers of fiber or 1 to about 24 layers of fiber. Any wall thickness or number of fiber layers can be used, as described above.

The braking material 690 can include an adhesion layer 692, 693, a strike layer 694, 695, and a friction material layer 696, 697. The adhesion layer 692, 693 can improve bonding of the strike layer 694, 695 to the first brake track 630 and the second brake track 635. The adhesion layer 692, 693 can be, for example, a resin, a plastic, a conductive material, a metal, nickel, chromium, a soft copper, a hard copper, a silane such as an organosilane, a foil, a conductive paint, a metal fabric, a metalized fabric, and/or or a conductive resin. The adhesion layer 692, 693 can be laid down using a mask. In another embodiment, the adhesion layer 692, 693 can be a conductive foil applied to the first sidewall 610 and the second sidewall 615 or co-molded with the first sidewall 610 and the second sidewall 615. In some embodiments, the adhesion layer 692, 693 can be optional. In other embodiments, the adhesion layer 692, 693 can be integrated into the structure of the clincher bicycle wheel rim 600. For example, a material of the clincher bicycle wheel rim 600 can include a metal base, metal particles or fibers, or prepreg including conductive resin or fibers.

The adhesion layer 692, 693 can be coated with a strike layer 694, 695. The strike layer 694, 695 can provide a substrate for the friction material layer 696, 697. The strike layer 694, 695 can be, for example, a hard copper, nickel, chrome, a nickel-chrome alloy, a cobalt-phosphorous material, aluminum, titanium, gold, or any other metal. The strike layer 694, 695 can be applied to the adhesion layer 592, 593 using a variety of methods including, without limitation, electroless plating, electroplating, sputtering, thermal spray/plasma deposition, and evaporation. Alternatively, the strike layer 694, 695 can be applied directly to a raw rim.

The strike layer 694, 695 can be coated with a friction material layer 696, 697. The friction material layer 696, 697 can provide a roughened surface for a brake pad. The friction material layer 696, 697 can include a formed surface including friction material grains with an average grain size between 2 nm and 50,000 nm. However, any average grain size can be used. The friction material layer 696, 697 can be formed of a plurality of grain types and shapes. For example, the grains can be shaped as spheres, pyramids, threads, rods, flakes, globules, or any other shape. The friction material layer 696, 697 can be formed of a plurality of different grain sizes. For example, a first portion of the friction material layer 696, 697 can be a grain size between 2 nm and 10,000 nm; a second portion of the friction material layer 696, 697 can be a grain size between 10,000 nm and 20,000 nm; and a third portion of the friction material layer 696, 697 can be a grain size between 20,000 nm and 50,000 nm. The friction material layer 696, 697 can include a base or filler material, for example, material plated with a plating bath. The base or filler material can be the same composition as the grains. A finished surface of the braking material 590 can, for example, have a predetermined roughness. The predetermined roughness can be, for example, in a range of 1-30 microns, a range of 5-15 microns, a range of 1-80 microns, or any other roughness. The friction material layer 696, 697 can include multiple layers, including layers of different materials. For example, a first layer can provide flex and a second capping layer can provide a tough surface. The friction material layer 696, 697 can be about 2 microns to about 200 microns thick; however, any thickness can be used. In another embodiment, the friction material layer 696, 697 can be about 25 microns to about 100 microns thick.

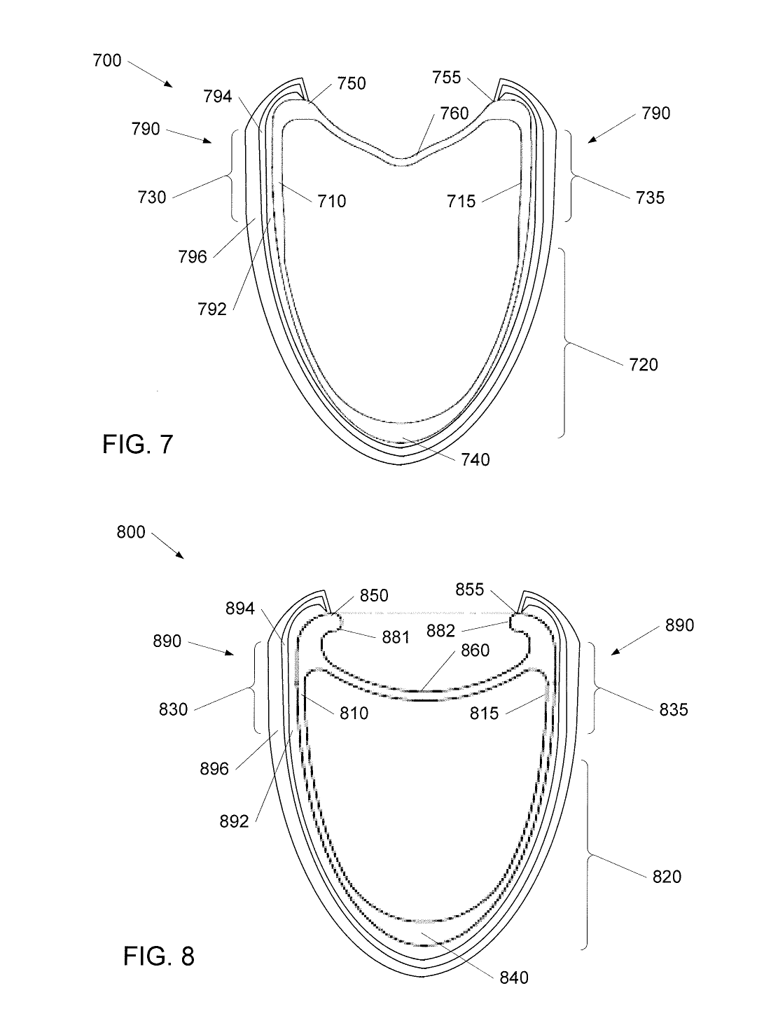

Referring to FIG. 7, a section view of a tubular bicycle wheel rim 700 in accordance with an illustrative embodiment is shown. The tubular bicycle wheel rim 700 can include a first sidewall 710, a second sidewall 715, a tire well 760, a support structure 720, a first apex 750, a second apex 755, a spoke bed 740, a first brake track 730, and second brake track 735, as described above. FIG. 7 depicts braking material 790 located from the first apex 750, around the support structure 720, and to the second apex 755.

In one embodiment, the first and second sidewalls 710, 715 can be a fiber reinforced plastic such as a resin, for example, epoxy. The glass transition temperature (Tg) of the plastic/resin can be any temperature. In one embodiment, the resin can have a glass transition temperature (Tg) greater than 265 degrees Fahrenheit. In another embodiment, the Tg of the resin can be greater than 310 or 340 degrees Fahrenheit. In another embodiment, the Tg of the resin can be in a range of about 300 degrees Fahrenheit to about 420 degrees Fahrenheit. Plastic/resin with a glass transition temperature (Tg) greater than 310 degrees Fahrenheit can improve heat dissipation and thermal stability. The first and second sidewalls 710, 715 can be about 0.05 mm to about 3 mm thick and have 1 to about 7 layers of fiber or 1 to about 24 layers of fiber. Any wall thickness or number of fiber layers can be used, as described above.

The braking material 790 can include an adhesion layer 792, a strike layer 794, and a friction material layer 796. The adhesion layer 792 can improve bonding of the strike layer 794 to the first brake track 730 and the second brake track 735. The adhesion layer 792 can be, for example, a resin, a plastic, a conductive material, a metal, nickel, chromium, a soft copper, a hard copper, a silane such as an organosilane, a foil, a conductive paint, a metal fabric, a metalized fabric, and/or or a conductive resin. The adhesion layer 792 can be laid down using a mask. In another embodiment, the adhesion layer 792 can be a conductive foil applied to the first sidewall 710 and the second sidewall 715 or co-molded with the first sidewall 710 and the second sidewall 715. In some embodiments, the adhesion layer 792 can be optional. In other embodiments, the adhesion layer 792 can be integrated into the structure of the clincher bicycle wheel rim 700. For example, a material of the clincher bicycle wheel rim 700 can include a metal base, metal particles or fibers, or prepreg including conductive resin or fibers.

The adhesion layer 792 can be coated with a strike layer 794. The strike layer 794 can provide a substrate for the friction material layer 796. The strike layer 794 can be, for example, a hard copper, nickel, chrome, a nickel-chrome alloy, a cobalt-phosphorous material, aluminum, titanium, gold, or any other metal. The strike layer 794 can be applied to the adhesion layer 592, 593 using a variety of methods including, without limitation, electroless plating, electroplating, sputtering, thermal spray/plasma deposition, and evaporation. Alternatively, the strike layer 794 can be applied directly to a raw rim.

The strike layer 794 can be coated with a friction material layer 796. The friction material layer 796 can provide a roughened surface for a brake pad. The friction material layer 796 can include a formed surface including friction material grains with an average grain size between 2 nm and 50,000 nm. The friction material layer 796 can be formed of a plurality of grain types and shapes. For example, the grains can be shaped as spheres, pyramids, threads, rods, flakes, globules, or any other shape. The friction material layer 796 can be formed of a plurality of different grain sizes. For example, a first portion of the friction material layer 796 can be a grain size between 2 nm and 10,000 nm; a second portion of the friction material layer 796 can be a grain size between 10,000 nm and 20,000 nm; and a third portion of the friction material layer 796 can be a grain size between 20,000 nm and 50,000 nm. However, any average grain size can be used. The friction material layer 796 can include a base or filler material, for example, material plated with a plating bath. The base or filler material can be the same composition as the grains. A finished surface of the braking material 590 can, for example, have a predetermined roughness. The predetermined roughness can be, for example, in a range of 1-30 microns, a range of 5-15 microns, a range of 1-80 microns, or any other roughness. The friction material layer 796 can include multiple layers, including layers of different materials. For example, a first layer can provide flex and a second capping layer can provide a tough surface. The friction material layer 796 can be about 2 microns to about 200 microns thick; however, any thickness can be used. In another embodiment, the friction material layer 696, 697 can be about 25 microns to about 100 microns thick.

Referring to FIG. 8, a section view of a clincher bicycle wheel rim 800 in accordance with an illustrative embodiment is shown. The clincher bicycle wheel rim 800 can include a first sidewall 810, a second sidewall 815, a tire well 860, a support structure 820, a first apex 850, a second apex 855, a spoke bed 840, a first bead 881, a second bead 882, a first brake track 830, and second brake track 835, as described above. FIG. 8 depicts braking material 890 located from the first apex 850, around the support structure 820, and to the second apex 855.

In one embodiment, the first and second sidewalls 810, 815 can be a fiber reinforced plastic such as a resin, for example, epoxy. The glass transition temperature (Tg) of the plastic/resin can be any temperature. In one embodiment, the resin can have a glass transition temperature (Tg) greater than 265 degrees Fahrenheit. In another embodiment, the Tg of the resin can be greater than 310 or 340 degrees Fahrenheit. In another embodiment, the Tg of the resin can be in a range of about 300 degrees Fahrenheit to about 420 degrees Fahrenheit. Plastic/resin with a glass transition temperature (Tg) greater than 310 degrees Fahrenheit can improve heat dissipation and thermal stability. The first and second sidewalls 810, 815 can be about 0.05 mm to about 3 mm thick and have 1 to about 7 layers of fiber or 1 to about 24 layers of fiber. Any wall thickness or number of fiber layers can be used, as described above.

The braking material 890 can include an adhesion layer 892, a strike layer 894, and a friction material layer 896. The adhesion layer 892 can improve bonding of the strike layer 894 to the first brake track 830 and the second brake track 835. The adhesion layer 892 can be, for example, a resin, a plastic, a conductive material, a metal, nickel, chromium, a soft copper, a hard copper, a silane such as an organosilane, a foil, a conductive paint, a metal fabric, a metalized fabric, and/or or a conductive resin. The adhesion layer 892 can be laid down using a mask. In another embodiment, the adhesion layer 892 can be a conductive foil applied to the first sidewall 810 and the second sidewall 815 or co-molded with the first sidewall 810 and the second sidewall 815. In some embodiments, the adhesion layer 892 can be optional. In other embodiments, the adhesion layer 892 can be integrated into the structure of the clincher bicycle wheel rim 800. For example, a material of the clincher bicycle wheel rim 800 can include a metal base, metal particles or fibers, or prepreg including conductive resin or fibers.

The adhesion layer 892 can be coated with a strike layer 894. The strike layer 894 can provide a substrate for the friction material layer 896. The strike layer 894 can be, for example, a hard copper, nickel, chrome, a nickel-chrome alloy, a cobalt-phosphorous material, aluminum, titanium, gold, or any other metal. The strike layer 894 can be applied to the adhesion layer 592, 593 using a variety of methods including, without limitation, electroless plating, electroplating, sputtering, thermal spray/plasma deposition, and evaporation. Alternatively, the strike layer 894 can be applied directly to a raw rim.

The strike layer 894 can be coated with a friction material layer 896. The friction material layer 896 can provide a roughened surface for a brake pad. The friction material layer 896 can include a formed surface including friction material grains with an average grain size between 2 nm and 50,000 nm. However, any average grain size can be used. The friction material layer 896 can be formed of a plurality of grain types and shapes. For example, the grains can be shaped as spheres, pyramids, threads, rods, flakes, globules, or any other shape. The friction material layer 896 can be formed of a plurality of different grain sizes. For example, a first portion of the friction material layer 896 can be a grain size between 2 nm and 10,000 nm; a second portion of the friction material layer 896 can be a grain size between 10,000 nm and 20,000 nm; and a third portion of the friction material layer 896 can be a grain size between 20,000 nm and 50,000 nm. The friction material layer 896 can include a base or filler material, for example, material plated with a plating bath. The base or filler material can be the same composition as the grains. A finished surface of the braking material 590 can, for example, have a predetermined roughness. The predetermined roughness can be, for example, in a range of 1-30 microns, a range of 5-15 microns, a range of 1-80 microns, or any other roughness. The friction material layer 896 can include multiple layers, including layers of different materials. For example, a first layer can provide flex and a second capping layer can provide a tough surface. The friction material layer 896 can be about 2 microns to about 200 microns thick; however, any thickness can be used. In another embodiment, the friction material layer 696, 697 can be about 25 microns to about 100 microns thick.

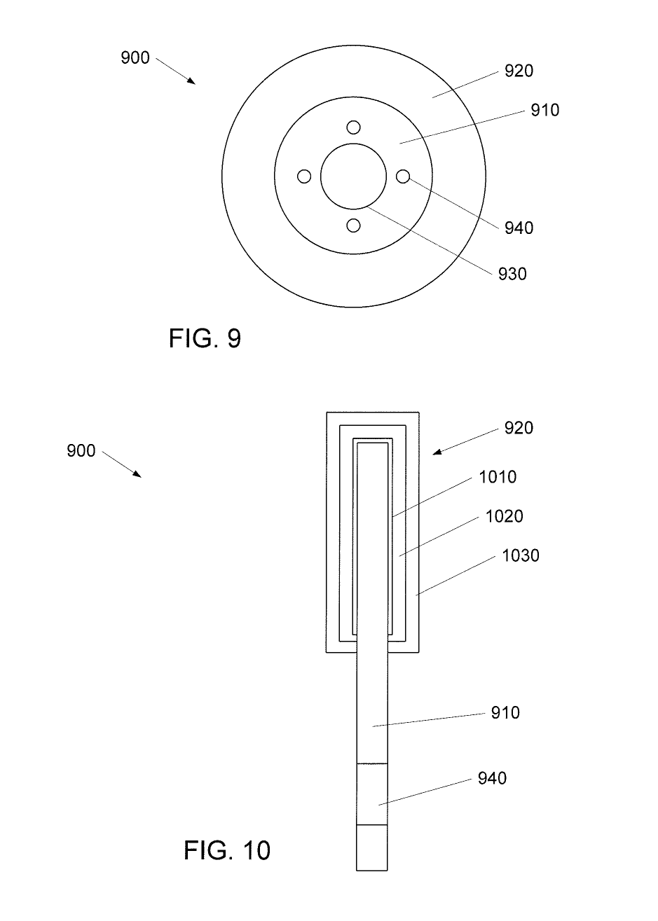

Referring to FIG. 9, a side view of a bicycle wheel rotor 900 in accordance with an illustrative embodiment is shown. The bicycle wheel rotor 900 can include a rotor base material 910, a hub hole 930, and mounting lug holes 940. The rotor base material 910 can be coated with a braking material 920. The bicycle wheel rotor 900 can be mounted on a bicycle wheel. The bicycle wheel rotor 900 can be pinched by a caliper in order to create friction between the bicycle wheel rotor 900 and a brake pad of the caliper. Alternatively, the entirety of the rotor base material 910 can be covered with braking material 920. Alternatively, the bicycle wheel rotor 900 can be integrated into a hub of a wheel. Alternatively, a hub of a wheel can be coated with braking material. In one embodiment, the hub with braking material can be used as a drum-type brake.

In one embodiment, the rotor base material 910 can be a fiber reinforced plastic such as a resin, for example, epoxy. The glass transition temperature (Tg) of the plastic/resin can be any temperature. In one embodiment, the resin can have a glass transition temperature (Tg) greater than 265 degrees Fahrenheit. In another embodiment, the Tg of the resin can be greater than 310 or 340 degrees Fahrenheit. In another embodiment, the Tg of the resin can be in a range of about 300 degrees Fahrenheit to about 420 degrees Fahrenheit. Plastic/resin with a glass transition temperature (Tg) greater than 310 degrees Fahrenheit can improve heat dissipation and thermal stability. The rotor base material 910 can be about 0.05 mm to about 3 mm thick and have 1 to about 7 layers of fiber or 1 to about 24 layers of fiber. Any rotor thickness or number of fiber layers can be used, as described above.

Referring to FIG. 10, a section view of the bicycle wheel rotor 900 of FIG. 9 in accordance with an illustrative embodiment is shown. The braking material 920 can include an adhesion layer 1010, a strike layer 1020, and a friction material layer 1030. The adhesion layer 1010 can improve bonding of the strike layer 1020 to the rotor base material 910. The adhesion layer 1010 can be, for example, a resin, a plastic, a conductive material, a metal, nickel, chromium, a soft copper, a hard copper, a silane such as an organosilane, a foil, a conductive paint, a metal fabric, a metalized fabric, and/or or a conductive resin. The adhesion layer 1010 can be laid down using a mask. In another embodiment, the adhesion layer 1010 can be a conductive foil applied to the first sidewall 810 and the second sidewall 815 or co-molded with the first sidewall 810 and the second sidewall 815. In some embodiments, the adhesion layer 1010 can be optional. In other embodiments, the adhesion layer 1010 can be integrated into the structure of the bicycle wheel rotor 900. For example, a material of the bicycle wheel rotor 900 can include a metal base, metal particles or fibers, or prepreg including conductive resin or fibers.

The adhesion layer 1010 can be coated with a strike layer 1020. The strike layer 1020 can provide a substrate for the friction material layer 1030. The strike layer 1020 can be, for example, for example, a hard copper, nickel, chrome, a nickel-chrome alloy, a cobalt-phosphorous material, aluminum, titanium, gold, or any other metal. The strike layer 1020 can be applied to the adhesion layer 1010 using a variety of methods including, without limitation, electroless plating, electroplating, sputtering, thermal spray/plasma deposition, and evaporation. Alternatively, the strike layer 1020 can be applied directly to a raw rotor.

The strike layer 1020 can be coated with a friction material layer 1030. The friction material layer 1030 can provides a roughened surface for a brake pad. The friction material layer 1030 can include a formed surface including friction material grains with an average grain size between 2 nm and 50,000 nm. The friction material layer 1030 can be formed of a plurality of grain types and shapes. For example, the grains can be shaped as spheres, pyramids, threads, rods, flakes, globules, or any other shape. The friction material layer 1030 can be formed of a plurality of different grain sizes. For example, a first portion of the friction material layer 1030 can be a grain size between 2 nm and 10,000 nm; a second portion of the friction material layer 1030 can be a grain size between 10,000 nm and 20,000 nm; and a third portion of the friction material layer 1030 can be a grain size between 20,000 nm and 50,000 nm. The friction material layer 1030 can include a base or filler material, for example, material plated with a plating bath. The base or filler material can be the same composition as the grains. A finished surface of the braking material 920 can, for example, have a predetermined roughness. The predetermined roughness can be, for example, in a range of 1-30 microns, a range of 5-15 microns, a range of 1-80 microns, or any other roughness. The friction material layer 1030 can include multiple layers, including layers of different materials. For example, a first layer can provide flex and a second capping layer can provide a tough surface. The friction material layer 1030 can be about 2 microns to about 200 microns thick; however, any thickness can be used. In another embodiment, the friction material layer 1030 can be about 25 microns to about 100 microns thick.

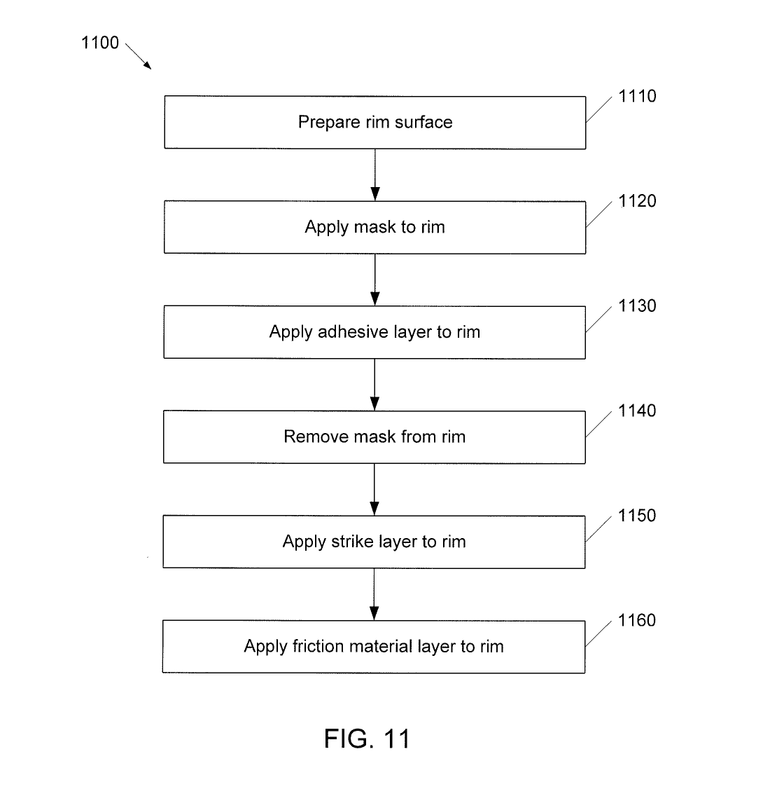

Referring to FIG. 11, a flow diagram of the braking material application process 1100 in accordance with an illustrative embodiment is shown. More or fewer operations can be included. The braking material application process 1100 can apply a braking material, such as described above, to a bicycle wheel rim or rotor.

In a preparation operation 1110, a surface of a bicycle wheel rim can be prepared for deposition. The surface of the bicycle wheel rim can be roughened in a range of about 2 microns to about 30 microns. In another embodiment, the surface of the bicycle wheel rim can be roughened in a range of about 2 microns to about 100 microns. The bicycle wheel rim can be cleaned, for example, with deionized water. In some embodiments, the surface of the bicycle wheel rim can be cleaned and/or activated with a chromic, nitric, or other acid. In other embodiments, the surface of the bicycle wheel rim can be activated, for example, by an organic solvent.

In a masking operation 1120, a mask can be applied to the surface of the bicycle wheel rim. The mask can be chosen based on the braking material application. For example, the mask can be a non-conductive material when electroplating process is used. The mask can be a non-reactive polymer when electroless plating is used. The mask can be a shield when sputtering, evaporation, or plasma deposition is used. The mask can be masking tape when conductive paint is the base. In one embodiment, the masking can cover a wheel well of the surface of the bicycle wheel rim. In another embodiment, the mask can expose braking tracks of the surface of the bicycle wheel rim.

In one embodiment, in an adhesive layer operation 1130, an adhesive layer can be applied to the surface of the bicycle wheel rim. In one embodiment, the adhesive layer can be a standard resin. In other embodiments, the adhesive layer can be, for example, a resin, a plastic, a conductive material, a metal, nickel, chromium, a soft copper, a hard copper, a silane such as an organosilane, a foil, a conductive paint, a metal fabric, a metalized fabric, an adhesive, an activator, and/or or a conductive resin. The adhesive layer will only bond to the unmasked areas of the surface of the bicycle wheel rim. Alternatively, an adhesive foil can be applied to the surface of the bicycle wheel rim or co-molded with the bicycle wheel rim. In other embodiments, the adhesion layer can be integrated into the structure of the bicycle wheel rim. For example, a material of the bicycle wheel rim can include a metal base, metal particles or fibers, or prepreg including conductive resin or fibers. Alternatively, the adhesive layer operation 1130 can be optional.

In one embodiment, in an unmasking operation 1140, the mask can be removed from the bicycle wheel rim. After the unmasking operation 1140, the adhesive layer with remain only in a predetermined area of the bicycle wheel rim such as the brake tracks or covering the outside of the rim, apex-to-apex. Alternatively, the mask can be removed after operations 1150 or 1160.

In a strike layer operation 1150, a strike layer can be applied to the adhesive layer. The strike layer can be a for example, a hard copper, nickel, chrome, a nickel-chrome alloy, a cobalt-phosphorous material, aluminum, titanium, gold, or any other metal. The strike layer 694, 695 can be applied to the adhesion layer 692, 693 using a variety of methods including, without limitation, electroless plating, electroplating, sputtering, thermal spray/plasma deposition, and evaporation. In some embodiments, the strike layer will only bond to the adhesive layer. Alternatively, the mask can remain or a new mask applied to prevent the strike layer from bonding to unwanted areas of the bicycle wheel rim. Alternatively, the strike layer operation 1150 can be optional, for example, where electroless plating, sputtering, or plasma spray is used.

In a friction material layer operation 1160, a friction material layer can be applied to the strike layer. The friction material layer can be applied as a single layer or a plurality of layers. The friction material layer can provide a roughened surface for a brake pad. The strike layer 1020 can include a formed surface including friction material grains with an average grain size between 2 nm and 50,000 nm. However, any average grain size can be used. The friction material layer can be formed of a plurality of grain types and shapes. For example, the grains can be shaped as spheres, pyramids, threads, rods, flakes, globules, or any other shape.

The friction material layer can be formed of a plurality of different grain sizes. For example, a first portion of the friction material layer can be a grain size between 2 nm and 10,000 nm; a second portion of the friction material layer can be a grain size between 10,000 nm and 20,000 nm; and a third portion of the friction material layer can be a grain size between 20,000 nm and 50,000 nm.

The friction material layer can include multiple layers, including layers of different materials. For example, a first layer can provide flex and a second capping layer can provide a tough surface. The friction material layer can be about 2 microns to about 200 microns thick; however, any thickness can be used. In another embodiment, the friction material layer can be about 25 microns to about 100 microns thick.

A finished surface of the bicycle wheel rim can, for example, for example, have a predetermined roughness. The predetermined roughness can be, for example, in a range of 1-30 microns, a range of 5-15 microns, a range of 1-80 microns, or any other roughness.

In one embodiment, the friction material layer can be a metal or part-metal such as nickel, nickel-cobalt, cobalt-phosphorous, chromium, cobalt-chromium, an alloy thereof, or any other metal. In another embodiment, the braking material can be a ceramic such as a conductive ceramic. In another embodiment, the friction material layer can be a combination of metal and ceramic. In another embodiment, the friction material layer can include nanostructures, microstructures, fine particulate, graphene and diamond material. The friction material layer can include Ni, Cr, Cu, Co, Sn, Fe, Pt, Zn Ag, Au, Mo, W, B, C, P, S, Si, or an alloy thereof. The friction material layer can have an average grain size between 2 nm and 50,000 nm. In one embodiment, the friction material layer can have an average grain size between 5,000 nm and 15,000 nm. However, any average grain size can be used.

The friction material layer can be applied to the strike layer using a variety of methods including, without limitation, electroless plating, electroplating, sputtering, thermal spray/plasma deposition, and evaporation. In some embodiments, the friction material layer can only bond to the strike layer. Alternatively, the mask can remain or a new mask applied to prevent the friction material layer from bonding to unwanted areas of the bicycle wheel rim. In another embodiment, the friction material layer can be applied such as described in U.S. Pat. No. 8,113,530, which is incorporated herein in its entirety.

In one embodiment, the friction material layer can be applied using an electroplating process. The rim can be submerged in an electrolyte containing friction material such as the grains described above. The electrolyte can be, for example, a nickel sulfate bath or a chromic bath. A first electrode can be attached to the strike layer and a second electrode can sit in the electrolyte. When current is run through the first electrode and second electrode, metal ions from the electrolyte as well as the grains can plate the strike layer. A layer of friction material can grow on the strike layer. The plating can be continued until the friction material layer is formed to a predetermined thickness and/or a predetermined roughness. A plurality of platings can be performed forming layers of various thicknesses and plating different materials.

Advantageously, the friction material layer of the bicycle wheel rim can enhance wet weather performance. Advantageously, the friction material layer can be hydrophobic. Advantageously, the friction material layer of the bicycle wheel rim can enhance heat dissipation during braking. Advantageously, the friction material layer of the bicycle wheel rim can enhance the strength of a spoke bed of the bicycle wheel rim.

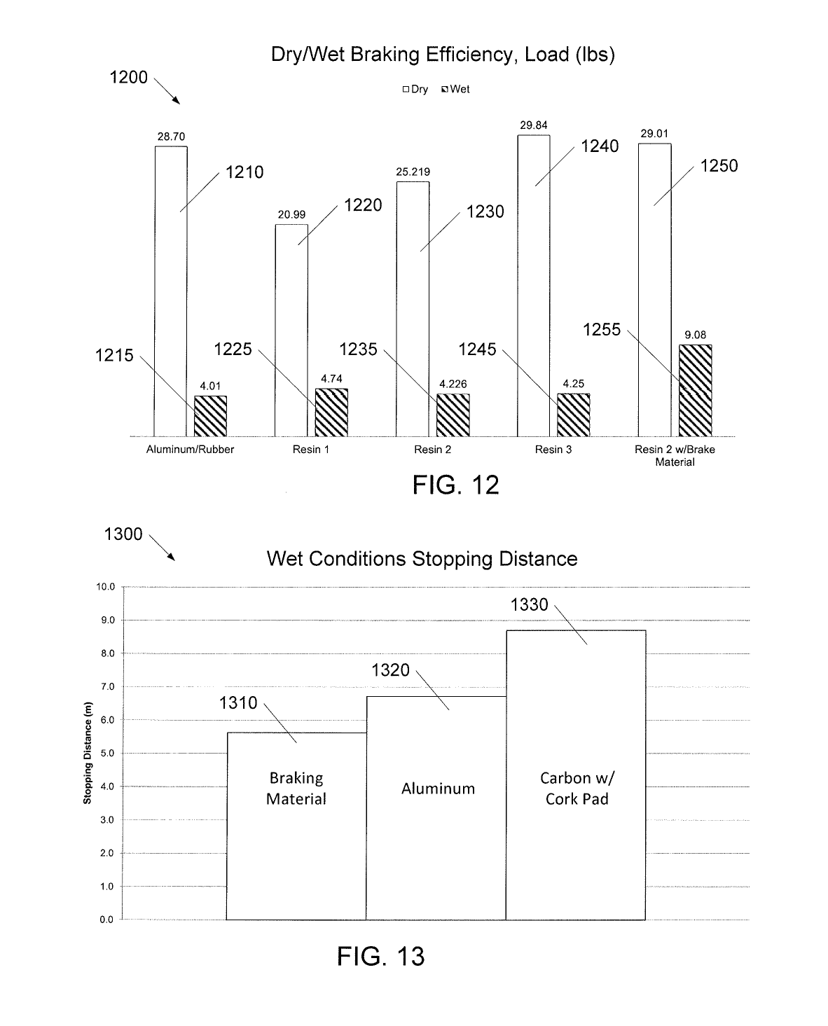

Referring to FIG. 12, a diagram of a graph of dry/wet braking force 1200 in accordance with an illustrative embodiment is shown. The graph of dry/wet braking force 1200 shows the tangential load in pounds created by a brake mechanism under dry and wet conditions for an aluminum rim with a Shimano R 55C3 brake pad, a carbon rim constructed of resin 1 with a cork brake pad, a carbon rim constructed of resin 2 with a cork brake pad, a carbon rim constructed of resin 3 with a cork brake pad, and a carbon rim constructed of resin 2 and coated with braking material with a Shimano R 55C3 brake pad. Resin 1, resin 2, and resin 3 were all standard carbon rim resins. The applied brake force was 10 lbs for each of the test materials. During the wet test, water was sprayed onto the brake track at a rate of greater than 8 ml/s.

Bar 1210 shows that the aluminum and rubber combination resulted in 28.70 pounds of tangential force created while the aluminum and rubber combination was dry. Bar 1215 shows that the aluminum and rubber combination resulted in 4.01 pounds of tangential force created while the aluminum and rubber combination was wet. Bar 1220 shows that the resin 1 combination resulted in 20.99 pounds of tangential force created while the resin 1 combination was dry. Bar 1225 shows the resin 1 combination resulted in 4.74 pounds of tangential force created while the resin 1 combination was wet. Bar 1230 shows that the resin 2 combination resulted in 25.219 pounds of tangential force created while the resin 2 combination was dry. Bar 1235 shows the resin 2 combination resulted in 4.226 pounds of tangential force created while the resin 2 combination was wet. Bar 1240 shows that the resin 3 combination resulted in 29.84 pounds of tangential force created while the resin 3 combination was dry. Bar 1245 shows the resin 3 combination resulted in 4.25 pounds of tangential force created while the resin 3 combination was wet. Bar 1250 shows that the resin 2 with braking material combination resulted in 29.01 pounds of tangential force created while the resin 2 with braking material combination was dry. Bar 1255 shows the resin 2 with braking material combination resulted in 9.08 pounds of tangential force created while the resin 2 with braking material combination was wet.

Thus, dry braking performance varied amongst the aluminum, resin, and resin with braking material rims. However, the resin with braking material rim outperformed typical aluminum and resin rims by a factor of two. Unexpectedly, the dry performance only improved a small amount whereas the wet performance doubled.

Referring to FIG. 13, a diagram of a graph of wet conditions stopping distance 1300 in accordance with an illustrative embodiment is shown. The graph of wet conditions stopping distance 1300 shows the distance before stopping in wet conditions. In each test, the wheel was spun up to 10 mph, water was sprayed on the braking track at a rate of 8 ml/s, and 60 lbs of cable tension was applied to a brake.

Bar 1310 shows that a carbon rim with braking material stopped after about 5.5 m. Bar 1320 shows that an aluminum rim stopped after about 6.5 m. Bar 1330 shows that a carbon rim stopped after about 8.8 m. Thus, the braking material improved stopping distance by about 3 m versus a typical carbon rim.

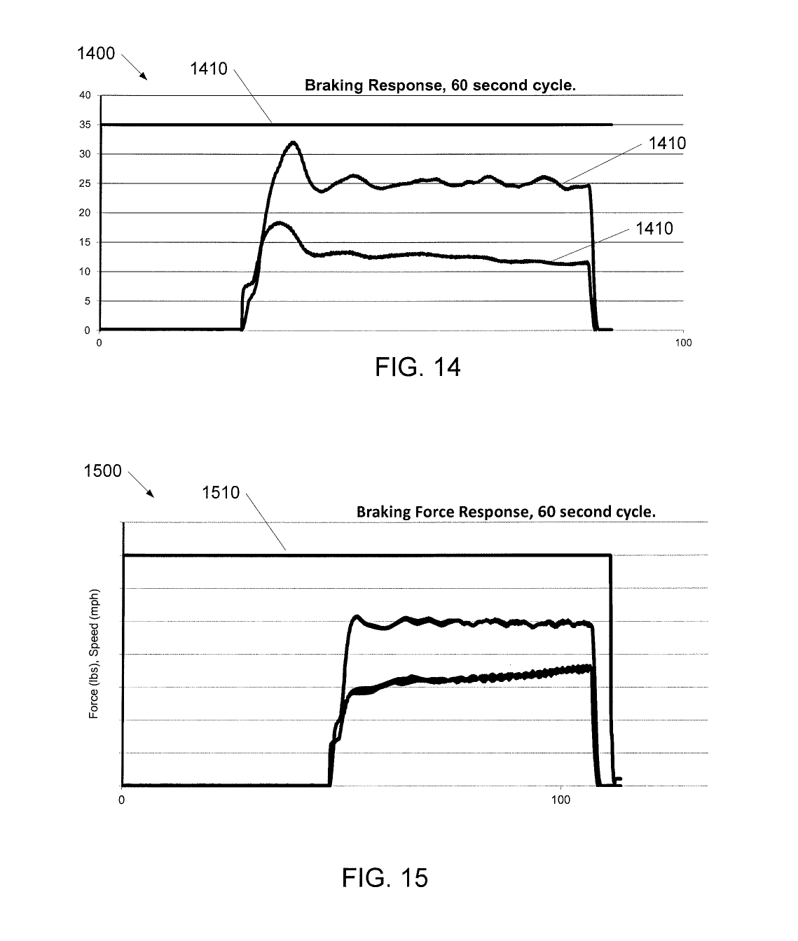

Referring to FIG. 14, a diagram of a graph of braking response for a carbon rim with cork brake pad 1400 in accordance with an illustrative embodiment is shown. The graph of braking response for a carbon rim with cork brake pad 1400 shows the tangential braking force over time created by applying a cable tension to a brake. An automatic control loop was used to regulate braking force.

Plot 1410 shows that the carbon rim was spun up to 35 mph. Plot 1430 shows that the cable tension was controlled at about 15 lbs. Plot 1420 shows the resultant tangential braking force. The plot 1420 shows that the resultant tangential braking force oscillated and was about 25 lbs. In addition, the plot 1430 shows that the cable tension had to be adjusted significantly to control for oscillations in braking force.

Referring to FIG. 15, a diagram of a graph of braking response for a carbon rim with braking material with Shimano™ R-55C3 brake pad 1500 in accordance with an illustrative embodiment is shown. The graph of braking response for a carbon rim with braking material with Shimano™ R-55C3 brake pad 1500 shows the tangential braking force over time created by applying a cable tension to a brake. An automatic control loop was used to regulate braking force.

Plot 1510 shows that the carbon rim with braking material was spun up to 35 mph. Plot 1530 shows that the cable tension was controlled at about 15 lbs. Plot 1520 shows the resultant tangential braking force. The plot 1520 shows that the resultant tangential braking force had minor oscillations and was about 25 lbs.

Compared to the carbon rim with cork brake pad of FIG. 14, the carbon rim with braking material provided a more stable braking response. The carbon rim with braking material did not experience large oscillations in resultant tangential braking force.

Variations in braking force can be caused by changes in the coefficient of friction between rim and brake pad, as temperatures increase from the heat generated by braking forces. Smoother braking force response over time indicates a more thermally stable coefficient of friction. A more stable coefficient of friction will yield a more predictable and consistent braking system for the rider.

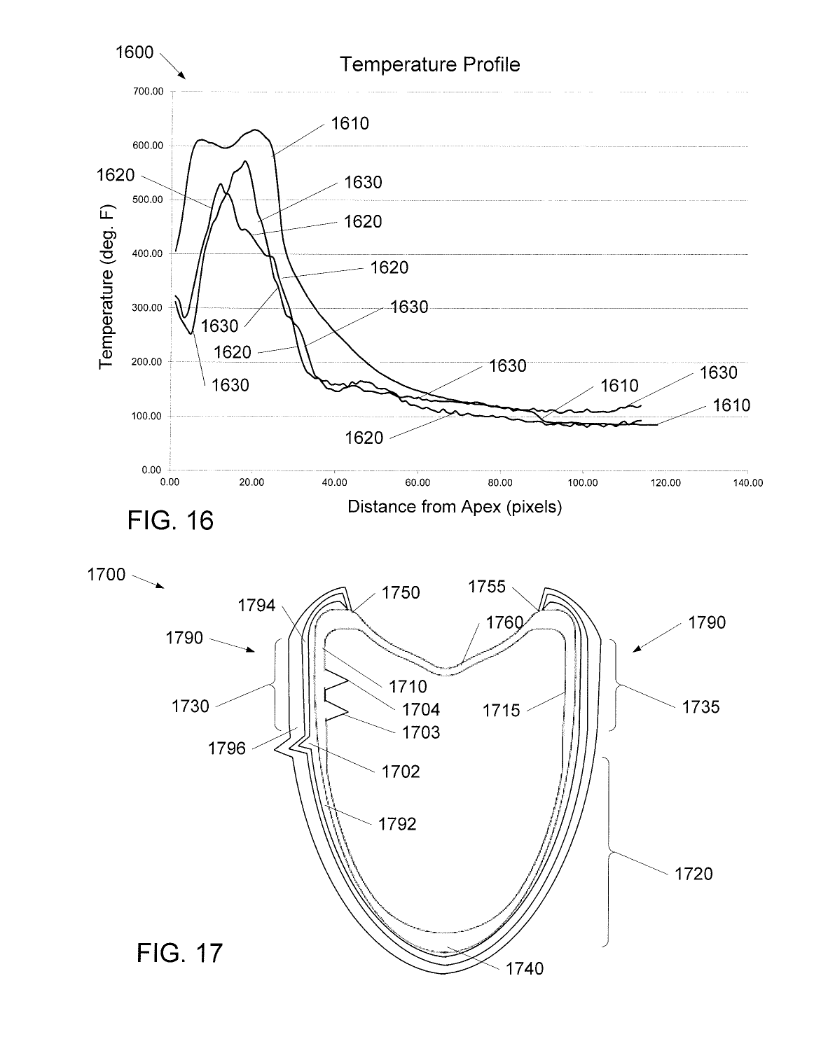

Referring to FIG. 16, a diagram of a graph of rim temperature profiles 1600 in accordance with an illustrative embodiment is shown. The graph of rim temperature profiles 1600 shows the temperature on a rim sidewall measured from an apex (thus, 0 is the apex). The temperatures were captured using a calibrated infrared camera. The temperatures were captured after braking for 50 seconds. Data shown is average of four frames taken from Infrared Camera video during test.

Plot 1610 shows that the temperature profile of a carbon rim with a cork brake pad. Plot 1620 shows that the temperature profile of a first carbon rim with braking material. Plot 1630 shows that the temperature profile of a second carbon rim with braking material. The first carbon rim and the second carbon rim had different layups.

The slope of temperature profile lines from 40 to 80 pixels show the effect of the increased thermal conductivity of the first braking material and the second braking material. The temperature profiles of plots 1620 and 1630 are flatter than plot 1610, indicating that more conduction is taking place, and that heat is being distributed down the entire surface of the rim. Increased conductivity allows entire rim surface to dissipate heat, and move heat away from the brake track, where heat failures can occur. The peak temperature differences can be attributed to the different brake pads being used.

Referring to FIG. 17, a section view of a tubular bicycle wheel rim 1700 in accordance with an illustrative embodiment is shown. The tubular bicycle wheel rim 1700 can include a first sidewall 1710, a second sidewall 1715, a tire well 1760, a support structure 1720, a first apex 1750, a second apex 1755, a spoke bed 1740, a first brake track 1730, and second brake track 1735, as described above. FIG. 17 depicts braking material 1790 located from the first apex 1750, around the support structure 1720, and to the second apex 1755. The braking material 1790 can include an adhesion layer 1792, a strike layer 1794, and a friction material layer 1796.

The tubular bicycle wheel rim 1700 can include outer fin 1702 and inner fins 1703, 1704. The outer fin 1702 can be located external to the first sidewall 1710. The outer fin 1702 can be part of the first sidewall 1710 and covered by the adhesion layer 1792, the strike layer 1794, and the friction material layer 1796. The outer fin 1702 can include multiple fins. The outer fin 1702 can be located on either side of the first brake track 1730.

The inner fins 1703, 1704 can be located external to the first sidewall 1710. The inner fins 1703, 1704 can part of the first sidewall 1710. In one embodiment, the inner fins 1703, 1704 can be metalized or covered with braking material. The inner fins 1703, 1704 can include multiple fins. The outer fin 1702 can be located on either side of the first brake track 1730. The second sidewall 1715 can also include fins.

Advantageously, the braking material 1790 and fins 1702, 1703, 1704 can enhance heat dissipation during braking. Advantageously, the braking material 1790 and fins 1702, 1703, 1704 can enhance the strength of the tubular bicycle wheel rim 1700.

One or more flow diagrams may have been used herein. The use of flow diagrams is not meant to be limiting with respect to the order of operations performed. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative teens, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus, comprising:
a bicycle wheel rim, wherein:
at least a portion of the bicycle wheel rim includes a braking material; and
the braking material has a roughness of about 1 micron to about 80 microns.

2. The apparatus of claim 1, wherein the bicycle wheel rim comprises a fiber reinforced plastic.

3. The apparatus of claim 1, wherein a glass transition temperature of the fiber reinforced plastic is greater than about 265 degrees Fahrenheit.

4. The apparatus of claim 1, wherein a glass transition temperature of the fiber reinforced plastic is greater than about 310 degrees Fahrenheit.

5. The apparatus of claim 1, wherein the fiber reinforced plastic comprises carbon fiber.

6. The apparatus of claim 1, wherein the braking material comprises a strike layer and a friction material layer.

7. The apparatus of claim 6, wherein the braking material further comprises an adhesive layer.

8. The apparatus of claim 7, wherein the adhesive layer comprises at least one of a soft copper, a silane, a conductive paint, a foil, and a conductive resin.

9. The apparatus of claim 1, wherein the braking material comprises grains with an average grain size between 2 nm and 50,000 nm.

10. The apparatus of claim 1, wherein the grains comprise at least one of Ni, Cr, Cu, Co, Sn, Fe, Pt, Zn Ag, Au, Mo, W, B, C, P, S, Si, Ni—Co, Co—P, nanostructures, ceramic, particulate, graphene and diamond material.

11. The apparatus of claim 1, wherein the grains are shaped as at least one of spheres, pyramids, threads, rods, flakes, and globules.

12. The apparatus of claim 1, wherein the at least a portion of the bicycle wheel rim comprises a brake track of the bicycle wheel rim.

13. The apparatus of claim 12, wherein a sidewall behind the brake track is about 0.05 mm to about 2 mm thick and has 1 to about 7 layers.

14. A method, comprising:
roughening a bicycle wheel rim surface;
applying an adhesive layer to the bicycle wheel rim surface;
applying a strike layer to the adhesive layer; and
applying a friction material layer to the strike layer;
wherein the friction material layer has a roughness of about 1 micron to about 80 microns.

15. The method of claim 14, wherein applying the friction material layer to the strike layer comprises at least one of electroless plating, electroplating, sputtering, thermal spray, plasma deposition, and evaporation.

16. The method of claim 14, wherein the adhesive layer comprises at least one of a soft copper, a silane, a conductive paint, a foil, and a conductive resin.

17. The method of claim 14, wherein the friction material layer comprises grains with an average grain size between 2 nm and 50,000 nm.

18. The method of claim 17, wherein the grains comprise at least one of Ni, Cr, Cu, Co, Sn, Fe, Pt, Zn Ag, Au, Mo, W, B, C, P, S, Si, Ni—Co, Co—P, nanostructures, ceramic, particulate, graphene and diamond material.

19. An apparatus, comprising:
a bicycle wheel rim, wherein:
at least a portion of the bicycle wheel rim includes:
an adhesive layer;
a strike layer; and
a friction material layer;
wherein:
the friction material layer comprises grains with an average grain size between 2 nm and 50,000 nm; and
the bicycle wheel rim comprises a fiber reinforced plastic having a glass transition temperature greater than about 265 degrees Fahrenheit.

20. The apparatus of claim 19, wherein the grains comprise at least one of Ni, Cr, Cu, Co, Sn, Fe, Pt, Zn Ag, Au, Mo, W, B, C, P, S, Si, Ni—Co, Co—P, nanostructures, ceramic, particulate, graphene and diamond material.
